(19) United States
(12) Patent Application Publication
(10) Pub. No.: US 2009/0298347 A1
(43) Pub. Date: Dec. 3, 2009

(54) Audio jack connector

(76) Inventors: Yin Lung Wu, Tu-Cheng City (TW); Ming Chiang Chen, Tu-Cheng City (TW); Min Song, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,906

(22) Filed: May 28, 2008

(51) Int. Cl. H01R 24/04

(52) U.S. Cl. 439/668

(57) ABSTRACT

An audio jack connector suits to selectively engaging with either a first multi-pole plug or a second multi-pole plug having more poles than the first multi-pole plug, each of the multi-pole plugs has a plurality of poles insulated with each other by insulating rings arranged therebetween. The audio jack connector includes an insulating housing having a chamber extending inward from a front thereof, and terminal groups. A plurality of grooves are defined in the insulating housing and connect to the chamber. The terminal groups are disposed in the corresponding grooves and project into the chamber, when either of the first and the second multi-pole plugs is respectively inserted into the chamber, the terminal groups are against the multi-pole plug, wherein at least one of the terminal groups is against one of the insulating rings of the first multi-pole plug.

### BACKGROUND OF THE INVENTION

1. Field of the Invention

This present invention relates to a connector, and more specifically to an audio jack connector suitable for engaging with at least two different multi-pole plugs.

2. The Related Art

An earphone connects with an electronic device via an audio jack connector, such as a MP3, a mobile phone. With the audio jack connector, a user can listen to the audio signals delivered through the electronic device.

At present, the audio jack connector arranged in the electronic device just connects with a kind of audio plug which is arranged in the end of the earphone, such as a tri-pole plug, a four-pole plug. In order to connect a tri-pole plug and a four-pole plug, the electronic device must arrange two audio jack connectors to receive the two plugs respectively, then the volume of the electronic device is large for the two plugs arranged in the electronic device, the cost of the electronic device rises.

### SUMMARY OF THE INVENTION

An object of the invention is to provide an audio jack connector adapted for selectively engaging with either a first multi-pole plug or a second multi-plug having more poles than the first multi-pole plug. Both the poles of the first and the second multi-pole plugs are respectively arranged along an axis direction of the first and the second multi-pole plugs and insulated with each other by insulating rings arranged therebetween. The audio jack connector includes an insulating housing and a plurality of terminal groups. The insulating housing has a chamber extending along a longitudinal direction thereof and opening to a front face thereof for mating with the multi-pole plug, a plurality of grooves are defined in the insulating housing and connect to the chamber. The terminal groups are disposed in the respective grooves of the insulating housing and project into the chamber. An amount of the terminal groups equals to that of the poles of the second multi-pole plug which has most poles so that the poles can physically and electrically contact the terminal groups one-to-one, and one of the terminal groups are configured for physically contacting one of the insulating rings of the multi-pole plug which has less poles.

As above description, the audio jack connector can connect at least two different multi-pole plugs, the volume and the cost of the electronic device where the audio jack connector is arranged are reduced.

### BRIEF DESCRIPTION OF THE DRAWINGS

The invention, together with its objects and the advantages thereof may be best understood by reference to the following description taken in conjunction with the accompanying drawings, in which:

FIG. 1 is a perspective view of an audio jack connector according to the present invention;

FIG. 2 is an exploded perspective view of the audio jack connector;

FIG. 3 is a cross-sectional view showing the audio jack connector;

FIG. 4 is a cross-sectional view of the audio jack connector for showing the assembly relation between a sixth contact terminal, a seventh contact terminal and an insulating housing of the audio jack connector;

FIG. 5 is a cross-sectional view showing a tri-pole plug inserted in the audio jack connector; and

FIG. 6 is a cross-sectional view showing a four-pole plug inserted in the audio jack connector.

### DETAILED DESCRIPTION OF THE PREFERRED EMBODIMENT

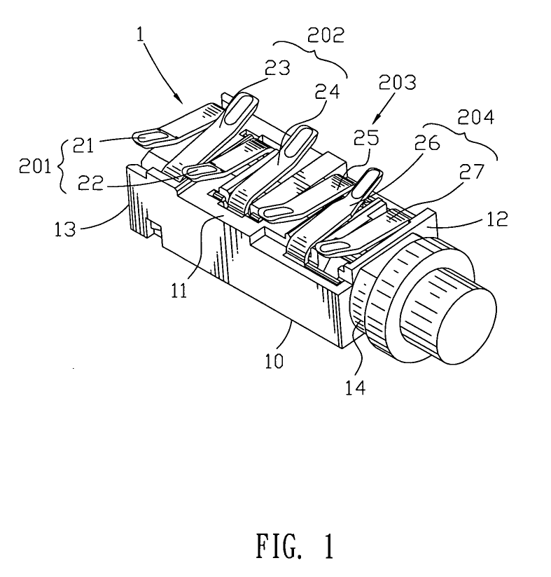

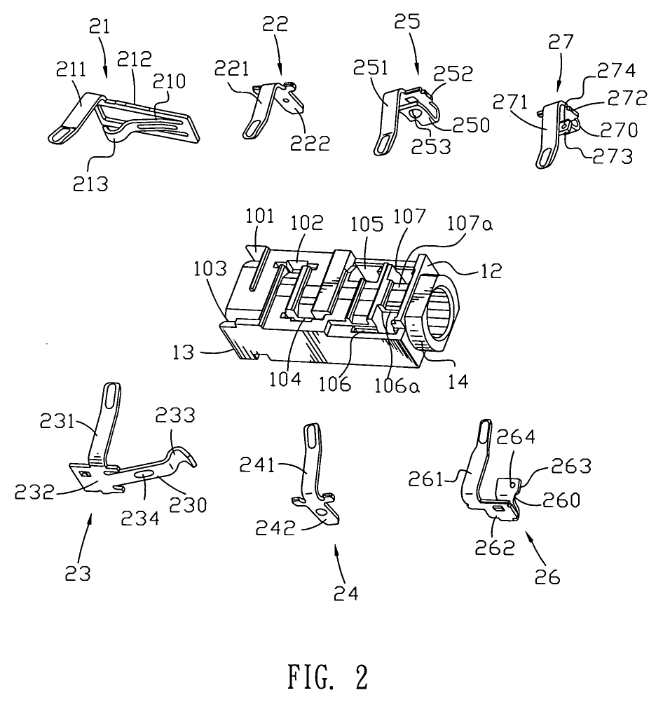

The present invent discloses an audio jack connector which is suitable for engaging with either a first multi-pole plug 30 or a second multi-pole plug 40 having more poles than the first multi-pole plug 30. Please referring to FIGS. 1 and 2, the audio jack connector 1 includes an insulating housing 10 and a plurality of terminals received in the insulating housing 10. The insulating housing 10 showing a rectangular solid shape has a bottom surface 11, a front end surface 12, a rear end surface 13. The bottom surface 11 defines a plurality of grooves which include a first groove 101, a second groove 102, a third groove 103, a fourth groove 104, a fifth groove 105, a sixth groove 106 and a seventh groove 107, and a first resisting block 106a and a second resisting block 107a are formed in the sixth groove 106 and the seventh groove 107 respectively. The front end surface 12 extends outward to form a joint 14 showing a column shape. The insulating housing 10 has a chamber 15 extended inward from the front of the joint 14 along an axis direction of the insulating housing 10. The chamber 15 is used to receive either of the multi-pole plugs 30, 40. A platform 16 protrudes inward from one side of the insulating housing 10 and is located in the third groove 103.

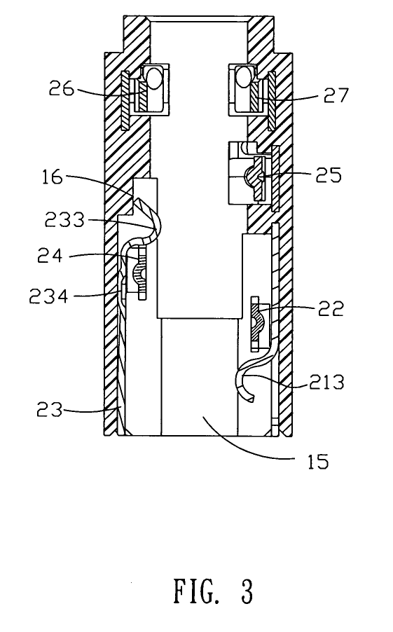

In FIGS. 2 and 3, the terminals received in the insulating housing 10 are divided into four terminal groups which are named as a first terminal group 201, a second terminal group 202, a third terminal group 203 and a fourth terminal group 204. The first terminal group 201 includes a first terminal 21 and a second terminal 22, which are received in the first groove 101 and the second groove 102 respectively. The first terminal 21 has a first fixing portion 212 fixed in the first groove 101, a first connecting arm 211 and a first elastic arm 210. The first fixing portion 212 shows a rectangular-ring shape, a bottom of the first fixing portion 212 extends inward to form the first connecting arm 211. The first connecting arm 211 shows a strip shape, when the first terminal 21 is received in the first groove 101, the first connecting arm 211 is located under the bottom surface 11. A front of the first fixing portion 212 extends rearward and bends inward to form the first elastic arm 210, and a rear end of the first elastic arm 210 extends to form a first contact portion 213 which extends into the chamber 15. The second terminal 22 has a second fixing portion 222 which is received in the second groove 102 and resists the first elastic arm 210, and a second connecting arm 221. The second connecting arm 221 extends inward from a bottom of the second fixing portion 212, and the second connecting arm 221 is located under the bottom surface 11. When either of the plugs 30, 40 is inserted into the chamber 15 of the insulating housing 10, the first contact portion 213 is pressed by either of the plugs 30, 40, and the first elastic arm 210 separates with the second fixing portion 222.

The second terminal group 202 includes a third terminal 23 and a fourth terminal 24, which are received in the third groove 103 and the fourth groove 104. The third terminal 23 has a fixing plate 232 showing a vertical board, a third connecting arm 231 and an third elastic arm 230. A bottom of the fixing plate 232 extends inward to form the third connecting arm 231. A front end of the fixing plate 232 extends inward to form the third elastic arm 230, a front of the third elastic arm 230 projects inward to form a third contact portion 233 which projects into the chamber 15. The middle of the third elastic arm 230 projects outward to form a lump 234. The structure of the fourth terminal 24 is the same to the second terminal 22. A free end of the third contact portion 233 is supported by the platform 16 when the third terminal 23 is received in the third groove 103. The fourth terminal 24 has a fourth fixing portion 242 which is inserted in the fourth groove 104 and resists the elastic arm 230, and a fourth connecting arm 241. A bottom of the fourth fixing portion 242 extends inward to form the fourth connecting arm 241. The fourth connecting arm 241 is located under the bottom surface 11. When either of the plugs 30, 40 is inserted into the chamber 15 of the insulating housing 10, the third contact portion 233 is pressed by either of the plugs 30, 40, and the third elastic arm 230 separates with the fourth fixing portion 242.

The third terminal group 203 includes a fifth terminal 25 which is received in the fifth groove 105. The fifth terminal 25 has a fifth fixing portion 252, a fifth connecting arm 251 and a fifth elastic arm 250. A top of the fifth fixing portion 252 curves inward to form the fifth elastic arm 250, a bottom end of the fifth fixing portion 252 extends inward to form the fifth connecting arm 251. The fifth fixing portion 252 is received in the fifth groove 105. The middle of the fifth elastic arm 250 projects inward to form a fifth contact portion 253. The fifth contact portion 253 projects into the chamber 15. The fifth connecting arm 251 is located under the bottom surface 11.

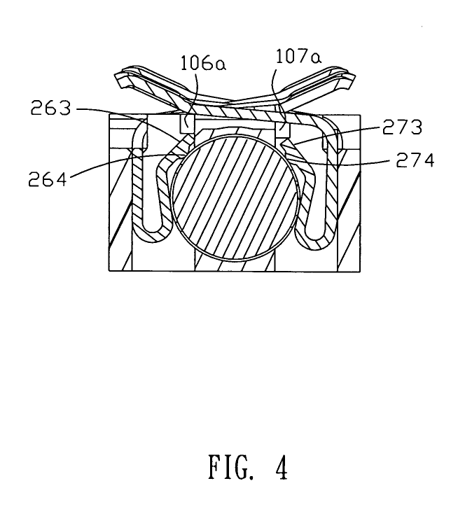

Referring to FIGS. 2, 3 and 4, the fourth terminal group 204 includes a sixth terminal 26 and a seventh terminal 27, which are received in the sixth groove 106 and the seventh groove 107 respectively. The sixth terminal 26 has a sixth fixing portion 262, a sixth connecting arm 261 and a sixth elastic arm 260. A bottom of the sixth fixing portion 262 extends inward to form the sixth connecting arm 261, the sixth connecting arm 261 is located under the bottom surface 11 when the sixth terminal 26 is inserted into the sixth groove 106. A top end of the sixth fixing portion 262 curves inward to form the sixth elastic arm 260. A bottom of the sixth elastic arm 260 extends inward to form a sixth contact portion 263. The middle of the sixth contact portion 263 projects downward to form a sixth projection 264. When the sixth terminal 26 is inserted into the sixth groove 106, the sixth fixing portion 262 is received in the sixth groove 106, the sixth projection 264 projects into the chamber 15, an end of the sixth contact portion 263 resists the first resisting block 106a. The structure of the seventh terminal 27 is similar with the sixth terminal 26, and the seventh terminal 27 and the sixth terminal 26 are arranged symmetrically in the insulating housing 10. The seventh terminal 27 includes a seventh fixing portion 272, a seventh connecting arm 271 and a seventh elastic arm 270. A bottom of the seventh fixing portion 272 extends inward to form the seventh connecting arm 271, the seventh connecting arm 271 is located under the bottom surface 11 when the seventh terminal 27 is inserted into the seventh groove 107. A top end of the seventh fixing portion 272 curves inward to form the seventh elastic arm 270. A bottom of the seventh elastic arm 270 extends inward to form a seventh contact portion 273. The middle of the seventh contact portion 273 projects downward to form a seventh projection 274. When the seventh terminal 27 is inserted into the seventh groove 107, the seventh fixing portion 272 is received in the seventh groove 107, the seventh projection 274 projects into the chamber 15, an end of the seventh contact portion 273 resists the second resisting block 107a.

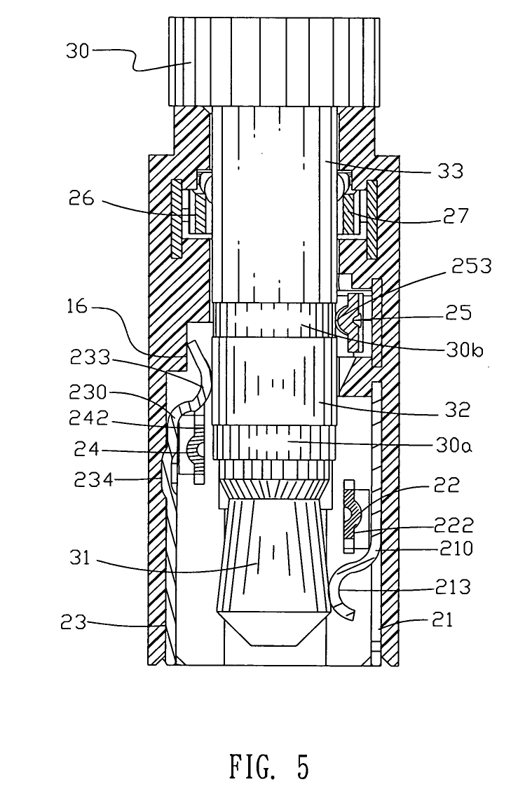

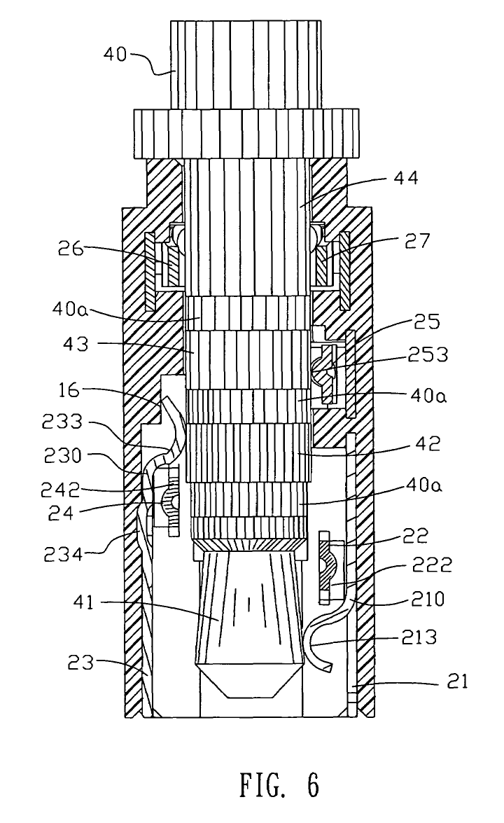

The first multi-pole plug 30 is a tri-pole plug and the second multiple plug 40 is a four-pole plug in this embodiment shown in FIGS. 5 and 6. The tri-pole plug 30 has a front pole 31, a middle pole 32, an end pole 33, a first insulating ring 30a arranged between the front pole 31 and the middle pole 32, and a second insulating ring 30b arranged between the middle pole 32 and the end pole 33. The four-pole plug 40 has a front pole 41, a middle pole 42, a rear pole 43, an end pole 44 and three insulating portions 40a. The insulating portions 40a are arranged between the four poles of the four-pole plug 40 to segregate the four poles. The length of the tri-pole plug 30 and the length of the four-pole plug 40 are approximately equivalent.

When the tri-pole plug 30 is inserted into the audio jack connector 1, the front pole 31 presses the first contact portion 213, the first elastic arm 210 separates with the second fixing portion 222 of the second terminal 22. The middle pole 32 presses the second contact portion 233, the second elastic arm 230 separates with the fourth fixing portion 242 of the fourth terminal 24. The fifth contact portion 253 presses the second insulating ring 30b, and the sixth projection 264 and the seventh projection 274 press the end pole 33.

When the four-pole plug 40 is inserted into the audio jack connector 1, the front pole 41 presses the first contact portion 213, the first elastic arm 210 separates with the second fixing portion 222 of the second terminal 22. The middle pole 42 presses the second contact portion 233, the second elastic arm 230 separates with the fourth fixing portion 242 of the fourth terminal 24. The fifth contact portion 253 presses the rear pole 43, and the sixth projection 264 and the seventh projection 274 press the end pole 44.

As above description, the audio jack connector 1 can connect the tri-pole plug 30 and the four-pole plug 40. When the audio jack connector 1 is arranged in an electronic device, the volume and the cost of the electronic device are reduced.

An embodiment of the present invention has been discussed in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. An audio jack connector adapted for selectively engaging with either a first multi-pole plug or a second multi-pole plug having more poles than the first multi-pole plug, both the poles of the first and the second multi-pole plugs being respectively arranged along an axis direction of the first and the second multi-pole plugs and insulated with each other by insulating rings arranged therebetween, the audio jack connector comprising:
an insulating housing having a chamber extending along a longitudinal direction thereof and opening to a front face thereof for mating with either of the first and the second multi-pole plugs, a plurality of grooves being defined in the insulating housing and communicating with the chamber; and
a plurality of terminal groups disposed in the respective grooves of the insulating housing and projecting into the chamber, an amount of the terminal groups equaling to that of the poles of the second multi-pole plug so that the poles can physically and electrically contact the terminal groups one-to-one, and one of the terminal groups being configured for physically contacting one of the insulating rings of the first multi-pole plug.

2. The audio jack connector as set forth in claim 1, wherein the first multi-pole plug is a tri-pole plug with three poles, and the second multi-pole plug is a four-pole plug with four poles, the amount of the terminal groups is four.

3. The audio jack connector as set forth in claim 1, wherein the terminal groups include a second terminal group, the second terminal group has a third terminal, the third terminal has a fixing plate fixed in a sidewall of the insulating housing, a third elastic arm extending from the fixing plate and a third contact portion extending from a free end of the third elastic arm and projecting into the chamber, the outside of the third elastic arm protrudes to form a lump.

4. The audio jack connector as set forth in claim 3, wherein the sidewall protrudes inward to form a platform located in the corresponding groove for supporting a free end of the third contact portion.
